(19) United States
(12) Patent Application Publication
(10) Pub. No.: US 2002/0118100 A1
(43) Pub. Date: Aug. 29, 2002

(54) Automobile warm-up timing device

(76) Inventor: Jon Gallo, Staten Island, NY (US)

Correspondence Address: Richard W. Goldstein, 2071 Clove Road, Staten Island, NY, 10304, US

(21) Appl. No.: 09/791,286

(22) Filed: Feb. 23, 2001

(51) Int. Cl. G08B 1/00

(52) U.S. Cl. 340/309.15; 340/438

(57) ABSTRACT

An automobile warm-up timing device having a control portion and a timing portion. The control portion is equipped with a start button. The start button initiates the timing portion. Also in communication with the timing portion are two lights, one red and one green. These lights signal to the driver whether or not it is safe to begin operation of the automobile. Once the start button is depressed, the red light illuminates to indicate that the car is not ready for operation, and still needs to warm-up. After a predetermined period of time has elapsed, as measured by the timing portion, the red light is extinguished, and the green light is illuminated. This transition indicates to the driver that the car engine is sufficiently warmed up and the car is safe to drive.

### BACKGROUND OF THE INVENTION

The invention relates to an automobile warm-up timing device. In particular, the invention is a timing device that is mounted in the interior of an automobile and signals to the driver when it is safe to begin driving said automobile.

The popularity and convenience of automobiles have caused them to become a necessity in many people'lives. Because of the expense of purchasing and repairing an automobile, many car owners try to maintain their vehicles in order to avoid future expenses.

One way of properly caring for an automobile is to give the car ample time to “warm-up” before proceeding to drive the car. This is especially important during the cold winter months when the car engine, as well as the fluids contained therein, are exposed to low temperatures for long periods of time. In order to ensure that the oil in the engine is properly distributed, the car engine needs to be brought to a higher temperature, so that the engine oil can thin sufficiently. However, it can be difficult to know exactly when the car has had sufficient time to warm up. Thus, many people will leave their cars running at idle for long periods of time, sometimes up to fifteen minutes, in order to allow the car engine time to warm up. While this practice does satisfy its intended goal, the associated side effects can be quite damaging. By way of example, leaving a car running idle can waste gas, as well as pollute the surrounding air.

U.S. Pat. No. 4,031,363 to Freeman et al. discloses a display apparatus for automotive vehicles. The display apparatus is capable of notifying a driver of the time and the number of days and/or miles to be traveled before service is necessary.

U.S. Pat. No. 5,684,455 to Williams et al. discloses a driver alert apparatus having an alert mechanism and speaker. The alarm will sound upon the driver'failure to press a proper sequence, and will not be silenced until the alarm stop button is depressed.

Thus, there exists a need for a device which notifies a driver of an automobile when said automobile is sufficiently warmed up and safe to drive. Such a device would aid in keeping the automobile in better working condition. Such a device is especially important during the colder weather.

While the available units may be suitable for the particular purpose employed, or for general use, they would not be as suitable for the purposes of the present invention as disclosed hereafter.

### SUMMARY OF THE INVENTION

In view of the foregoing disadvantages inherent in the prior art, the present invention provides an improved automobile warm-up timing device. As such, the general purpose of the present invention, which will be described subsequently in greater detail, is to provide a new and improved automobile warm-up timing device which has all the advantages of the prior art and none of the disadvantages.

To attain this, the present invention essentially comprises an automobile warm-up timing device having a control portion and a timing portion. The control portion is equipped with a “Start” button. This button controls operation of the device by being in communication with the timing portion. Depressing the “Start” button initiates the timing portion. Also in communication with the timing portion are two lights, one red and one green. These lights signal to the driver whether or not it is safe to begin operation of the automobile. Once the “Start” button is depressed, the red light illuminates to indicate that the car is not ready for operation, and still needs to warm-up. After a specified period of time has elapsed, as measured by the timing portion, the red light is extinguished, and the green light is illuminated. This transition indicates to the driver that the car engine is sufficiently warmed up and the car is safe to drive.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved automobile warm-up timing device which has all the advantages of the prior art and none of the disadvantages.

It is another object of the present invention to provide a new and improved automobile warm-up timing device which may be easily and efficiently manufactured and marketed.

It is a further object of the present invention to provide a new and improved automobile warm-up timing device which is of durable and reliable construction.

An even further object of the present invention is to provide a new and improved automobile warm-up timing device which is susceptible to a low cost of manufacture with regard to both materials and labor, and which accordingly is then susceptible of low prices of sale to the consuming public, thereby making such automobile warm-up timing devices economically available to the buying public.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### BRIEF DESCRIPTION OF THE DRAWINGS

In the drawings, like elements are depicted by like reference numerals. The drawings are briefly described as follows.

FIG. 1 is a front perspective view of an automobile warm-up timing device.

FIG. 2 is a rear elevational view of the automobile warm-up timing device.

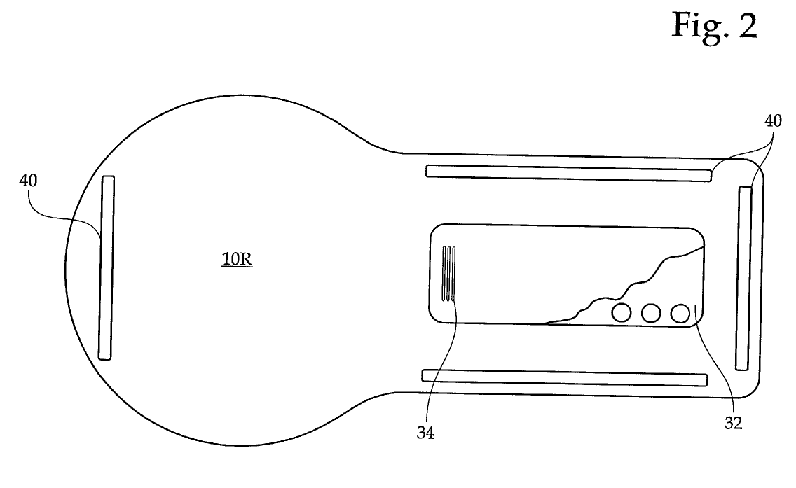

### DETAILED DESCRIPTION OF THE PREFERRED EMBODIMENTS

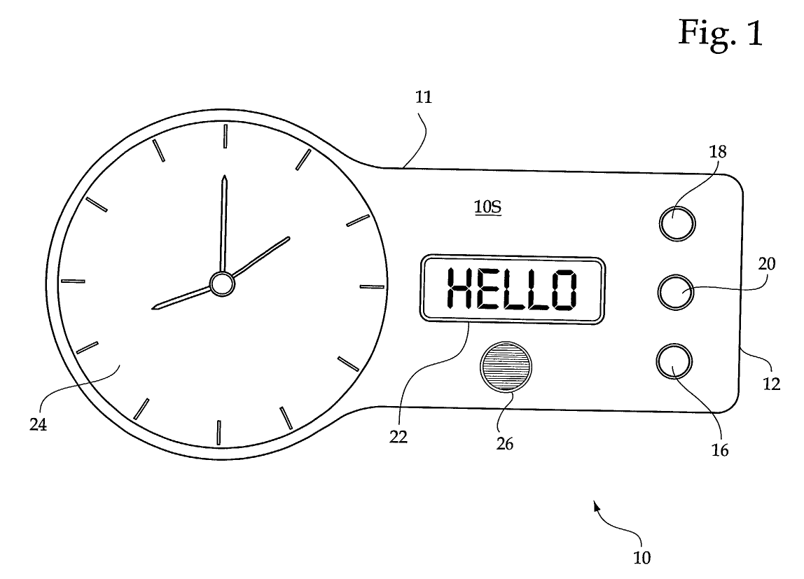

FIG. 1 illustrates an automobile warm-up timing device 10. The device 10 has housing 11 with a front surface 10S, a rear surface 10R, control portion 12 and a timing portion 14. The device 10 is mounted on an automobile dashboard for easy access by a driver of said automobile. A plurality of hook and loop fastener strips 40 are positioned along the edges of the rear surface 10R, said strips 40 enabling a driver to secure the device 10 in place within his or her automobile. These strips 40 further allow a driver to remove the device 10 in order to change the settings.

The control portion 12 of the device 10 is equipped with a “Start” button 16. This button 16 controls operation of the device 10 by being in communication with the timing portion 14. Depressing the “Start” button 16 initiates the timing portion 14. Also in communication with the timing portion 14 are two lights 18, 20 and a speaker 26. These lights signal to the driver whether or not it is safe to begin operation of the automobile. One light 18 is red, while the other light 20 is green. Once the “Start” button 16 is depressed, the red light 18 illuminates to indicate that the car is not ready for operation because it is still warming-up. After a specified period of time has elapsed, as measured by the timing portion 14, the red light 18 is extinguished, and the green light 20 is illuminated. Once the green light 20 is illuminated, an audible tone is emitted from the speaker 26. This transition indicates to the driver that the car engine is sufficiently warmed-up and the car is safe to drive.

Also positioned on the control portion 12 of the automobile warm-up timing device 10 is a LCD display 22. A plurality of greetings may be programmed into the device 10 and read on the LCD display 22 as the car is started. Examples of greetings include “Good Morning” and “Have a good day!”. Further, a count down of the timing period may be displayed on the LCD display 22.

A back plate 32 covers a portion of the rear surface 10R, particularly behind the control portion 12. A plurality of finger grips 34 are positioned on an end of the back plate 32 and allow one to remove said plate 32. Below the back plate 32 are operating buttons 42. These buttons 42 allow a user to preprogram the control portion 12 and the timing portion 14 of the device 10. By way of example, the period of time the car needs to warm up may be altered, as well as the greetings that are displayed on the LCD display 22.

The timing portion 14 of the device is positioned opposite from the control portion 12. The timing portion 14 comprises a clock/timer 24 that times the number of minutes until the car is warmed-up, as well as indicating the time of day. Depressing the “Start” button 16 activates the timing portion 14. Once the desired warm-up time period has elapsed, the green light 20 illuminates and the red light 18 is extinguished.

The device 10 may be powered by a variety of different sources. Batteries may be used to supply electricity to the device 10, thereby allowing said device 10 to operate. Alternatively, the device 10 may be wired in communication with the vehicle'thermostat.

In conclusion, herein is presented an automobile warm-up timing device. The invention is illustrated by example in the drawing figures, and throughout the written description. It should be understood that numerous variations are possible, while adhering to the inventive concept. Such variations are contemplated as being a part of the present invention.

What is claimed is:

1. An automobile warm-up timing device, for indicating to a driver when the automobile is sufficiently warmed-up and safe to drive, said device comprising:
a housing having a front surface and a rear surface;
a control portion situated on the front surface, said control portion having a start button and two indicator lights; and
a timing portion situated on the front surface, said portion having a clock and a timer, wherein the timer is activated by the start button and then measures a predetermined period of time and then illuminates a green light indicator to indicate that the automobile is safe to drive.

2. The automobile warm-up timing device as recited in claim 1, wherein one of the indicator lights on the control portion is red, such that when the start button is depressed, the red light is illuminated and is extinguished once a predetermined amount of time has elapsed.

3. The automobile warm-up timing device as recited in claim 2, wherein the control portion further comprises a LCD display that displays a plurality of pre-programmed greetings.

4. The automobile warm-up timing device as recited in claim 3, wherein a back plate is positioned over a portion of the rear surface of the device, behind the control portion, said plate covering a plurality of operating buttons which allow the driver to program the control portion as well as the timing portion.

5. The automobile warm-up timing device as recited in claim 4, wherein a plurality of hook and loop fastener strips are positioned along the edges of the rear surface, said strips enabling a driver to secure the device in place within his or her automobile.

6. The automobile warm-up timing device as recited in claim 5, wherein a speaker is positioned on the control panel, and where an audible tone is emitted through the speaker upon illumination of the green light indicator, signaling to the driver that the warm-up period has expired.

7. An automobile warm-up timing method, employed by a driver to determine when an automobile is sufficiently warmed-up and safe to drive, said device comprising a control portion having a start button, a red light indicator, and a green light indicator, and a timing portion, comprising the steps of:
activating the automobile by the driver;
initiating the timer and illuminating the red light by depressing the start button on the control portion;
timing a predetermined warm-up interval by the timer;
illuminating the green light by the timer at the end of the predetermined warm-up interval while simultaneously extinguishing the red light;
beginning to drive the automobile by the driver once the red light is extinguished and the green light is illuminated.
